(19) United States
(12) Patent Application Publication
(10) Pub. No.: US 2004/0074933 A1
(43) Pub. Date: Apr. 22, 2004

(54) Paint can and paint can lid with extendable and retractable lid spout

(76) Inventor: Trenley Tilbrook, Scottburgh (ZA)

Correspondence Address: John H. Oltman, Oltman, Flynn & Kubler, #415, 915 Middle River Drive, Ft. Lauderdale, FL, 33304-3585, US

(21) Appl. No.: 10/271,252

(22) Filed: Oct. 16, 2002

(51) Int. Cl. B67D 3/00

(52) U.S. Cl. 222/530

(57) ABSTRACT

A vessel and vessel lid for containing a flowable material is provided, including a retractable and extendable spout for pouring flowable material; and a vessel wall with a spout port into which the spout is sealingly fitted. The spout may include an bellows spout tube having a spout connected end sealingly connected around the spout port and having a spout protruding end extendable from the spout port by axially unfolding the bellows spout tube and retractable toward the spout port by axially folding the bellows spout tube, the spout protruding end including a spout opening. The spout opening preferably is lateral and adjacent to the spout protruding end, so that the spout opening collapses and closes when the spout is retracted and opens when the spout is extended. The spout protruding end optionally includes a spout port lid extending radially beyond the spout protruding end.

### BACKGROUND OF THE INVENTION

1. Field of the Invention

The present invention relates generally to the field of product container construction. More specifically the present invention relates to a vessel having a vessel wall with a spout port sealingly fitted with a retractable spout for retaining and pouring paint or other flowable material, in which the spout is covered with a metal spout port lid when retracted to shield the spout from heat and flames, the lid preferably being secured around the spout port with a double friction seal. The spout port lid preferably is attached to the spout protruding end. One preferred embodiment of the spout is a bellows retractable spout which folds toward and preferably into the vessel when retracted for vessel closure and storage and unfolds outwardly from the vessel when extended for use. Another preferred embodiment of the spout is a sliding retractable spout which slides sealingly within the spout port into the vessel when retracted and outwardly from the vessel when extended. For both preferred embodiments, the vessel preferably is a metal or plastic can having a can bottom wall, a cylindrical can side wall having a can side wall lower end sealingly connected to the can bottom wall and extending upwardly from the can bottom wall to a can side wall upper end and having a can top wall extending sealingly across the can side wall upper end, the spout port opening through the can top wall or the can side wall upper end.

2. Description of the Prior Art

There have long been vessels for containing flowable materials and having spouts for directing and metering the flow of a flowable material out of the vessel. A problem with these spouts has been that they protrude when not in use and can complicate storage of the vessel and can be a hazard which can hook into clothing of people close to the vessel. Another problem has been that a foldable spout typically must be formed of some type of plastic and many plastics melt and ignite when subjected to heat and flame, while metal spouts tend not to be retractable.

It is thus an object of the present invention to provide a vessel with a vessel spout which is extendable from the vessel for guiding the flow of flowable material out of the vessel and which is retractable for permitting more compact storage and transport of the vessel while preventing hooking of clothing and other unwanted contact with the spout.

It is another object of the present invention to provide such a vessel in which the spout has mounted at its protruding end a metal spout port lid having a double friction seal and which covers and seals around the retracted spout to contain the flowable material with the reliability of a standard paint can lid recognized in the industry, and also to provide a metal fire barrier shielding the spout and vessel contents against sparks and flame. The retractable spout and spout port lid preferably are provided as part of a standard sized vessel lid such as a paint can lid, the entire paint can lid itself having the double friction seal which is trusted as a standard in the industry and which can be fitted onto standard paint cans of existing and well known design.

It is another object of the present invention to provide such a vessel for which the spout can retract into the interior of the vessel.

It is still another object of the present invention to provide such a vessel having a spout sleeve inside the vessel for protecting the spout from the impact of flowable material during shaking of the vessel.

It is a still further object of the present invention to provide such a vessel having a retractable spout with a lateral spout opening at the side of the spout protruding end, the spout having a skewed bellows configuration in which the pitch of the bellows on the spout side having the spout opening is larger than the pitch of the bellows on the spout side opposite the spout opening, so that the spout opening automatically closes when the bellows spout is compressed for retraction and automatically opens when the bellows spout is elongated for extension.

It is finally an object of the present invention to provide such a vessel having a spout which is simple in construction, reliable and easy to manufacture.

### SUMMARY OF THE INVENTION

The present invention accomplishes the above-stated objectives, as well as others, as may be determined by a fair reading and interpretation of the entire specification.

A vessel for containing a flowable material is provided, including a retractable and extendable spout for pouring flowable material; and a vessel wall with a spout port into which the spout is sealingly fitted.

The vessel preferably is a can including a can bottom wall; a cylindrical can side wall having a can side wall lower end sealingly connected to the can bottom wall and extending upwardly from the can bottom wall to a can side wall upper end; and a can top wall extending sealingly across the can side wall upper end; where the spout port opens through the can top wall.

The spout preferably includes a bellows spout tube having a spout connected end sealingly connected around the spout port and having a spout protruding end extendable from the spout port by axially unfolding the bellows spout tube and retractable toward the spout port by axially folding the bellows spout tube, the spout protruding end including a spout opening. The spout opening preferably is lateral and adjacent to the spout protruding end, so that the spout opening collapses and closes when the spout is retracted and opens when the spout is extended. The spout protruding end optionally includes a spout port lid extending radially beyond the spout protruding end.

The can top wall preferably includes an upwardly opening spout port groove encircling the spout port and the spout port lid preferably includes a port lid flange extending from the spout port lid toward the spout port and sealingly fittable into the spout port groove upon full retraction of the spout tube. In addition, the can top wall preferably is separable from the can side wall, and the can side wall upper end includes a can lid rim extending radially inward with an upwardly opening can circumferential groove and the can top wall has a circumferential can lid flange sealingly fittable to the can circumferential groove.

The can top wall preferably includes a top wall inward face and a top wall outward face, the vessel additionally including an annular and tubular spout sleeve secured to the top wall inward face, encircling the spout port and extending into the can; so that, as the spout is folded and thereby retracted, at least a portion of the spout passes through the spout port and enters and is retained within the spout sleeve.

For another embodiment, the can top wall preferably includes a top wall inward face and a top wall outward face, and the spout includes a tubular spout sealingly and slidably mounted within the spout port, the spout including a spout inward end and a spout outward end and including an inward spout abutment rim protruding radially outward from the spout inward end for sealingly abutting the top wall inward face surrounding the spout port during full extension of the spout and has an outward spout abutment rim protruding radially outwardly from the spout outward end for sealingly abutting the top wall outward face surrounding the spout port during full retraction of the spout. The spout opening once again preferably is lateral and adjacent to the spout protruding end, so that the spout opening collapses and closes when the spout is retracted and opens when the spout is extended.

The vessel preferably additionally includes a plate pin; and a rotatable closure plate having a spout plate port and being rotatably mounted on the plate pin, the plate pin extending outwardly from can top wall; where the spout plate port rotates with the closure plate until the spout plate port registers with the spout port thereby permitting extension of the spout through the spout plate port, and rotates out of registration with the spout port so that the closure plate covers the spout port and the spout when the spout is retracted into the can, thereby sealingly closing the spout port. The vessel preferably still additionally includes an air entry port in the can top wall; and the closure plate preferably additionally includes an air plate port radially offset from the plate pin which registers with and thereby opens the air entry port simultaneously with spout plate port registration with the spout port, to equalize pressure inside the can and thereby to permit smooth flow of flowable material out of the can through the spout.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of a vessel in the form of a can fitted with the first embodiment of the retractable spout, including a bellows tube, with the spout retracted and the spout port lid closed over the spout port.

FIGS. 2 and 3 are perspective views as in FIG. 1 with the spout extended.

FIG. 4 is a close-up upper perspective view of another variation of the can lid formed by the removable can top wall, including the spout with the bellows tube extended.

FIG. 5 is a close-up lower perspective view of the can lid as in FIG. 4, revealing the spout sleeve.

FIG. 6 is a view generally as in FIG. 4, with the can rotated so that the spout opening is oriented more forwardly.

FIG. 7 is a perspective view of a can lid.

FIG. 8 is a perspective view of a vessel in the form of a can fitted with the second embodiment of the retractable spout, including an a uniform slidable tube, with the spout extended and without a spout port lid.

FIG. 9 is a view of the second embodiment as in FIG. 8 having the spout port lid, with the spout retracted and the spout port lid closed.

FIG. 10 is a broken away side view of the can fitted with the second embodiment of the spout, showing a section of the can side wall removed to reveal the retracted spout and the inward spout abutment rim.

FIG. 11 is a perspective view as in FIG. 8 but with a closure plate and air ports added, the closure plate being separated from the can in an exploded view.

FIG. 12 is a perspective view of the can of FIG. 1 fitted with the spout of the first embodiment, with the spout extended.

FIG. 13 is a perspective view of the spout of the first embodiment similar to that of FIGS. 2 and 3.

FIG. 14 is a broken away side view of a can fitted with the spout of the first embodiment, without the optional spout sleeve, the spout being extended.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### The Invention Generally

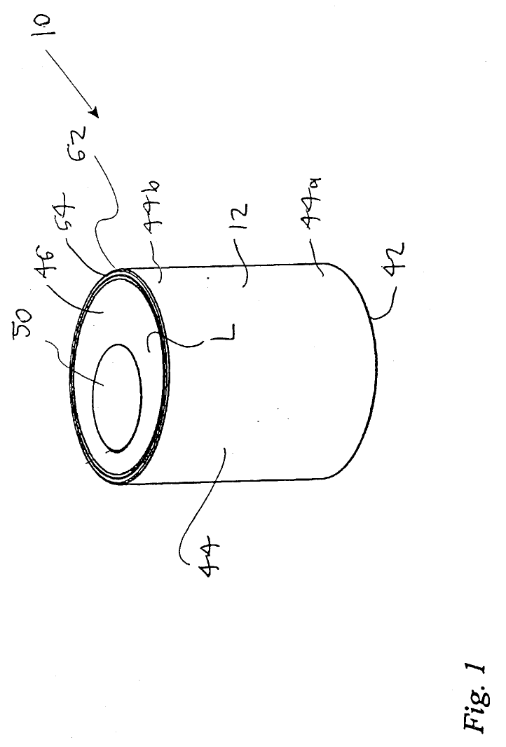

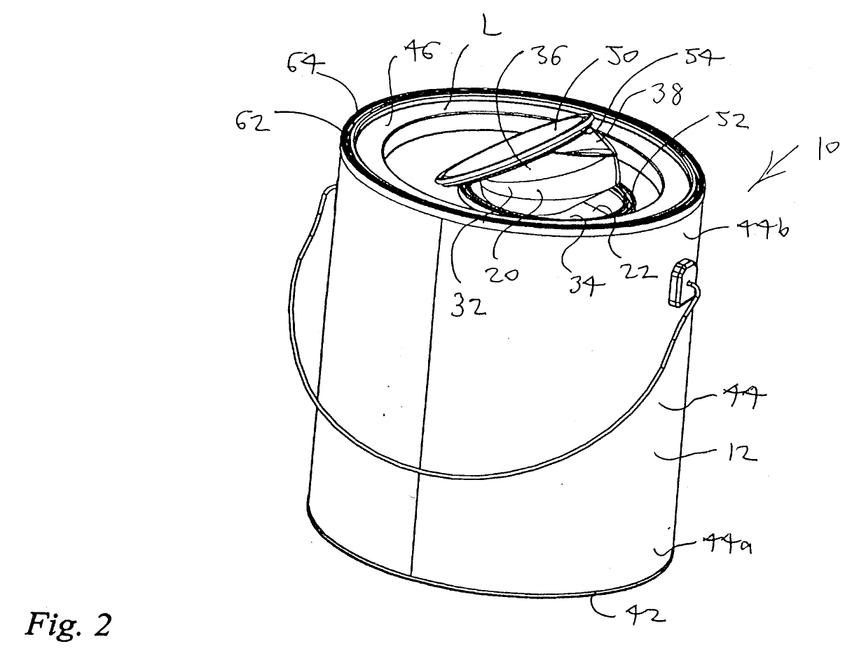

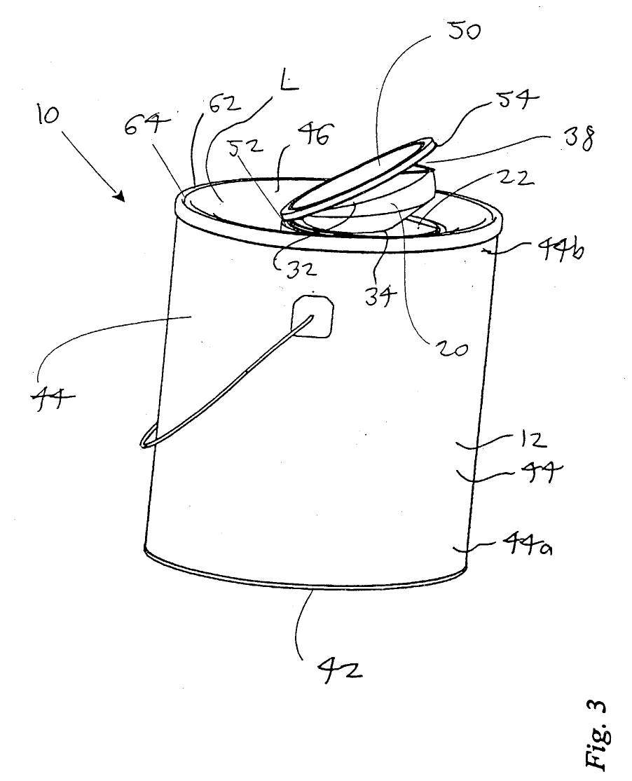

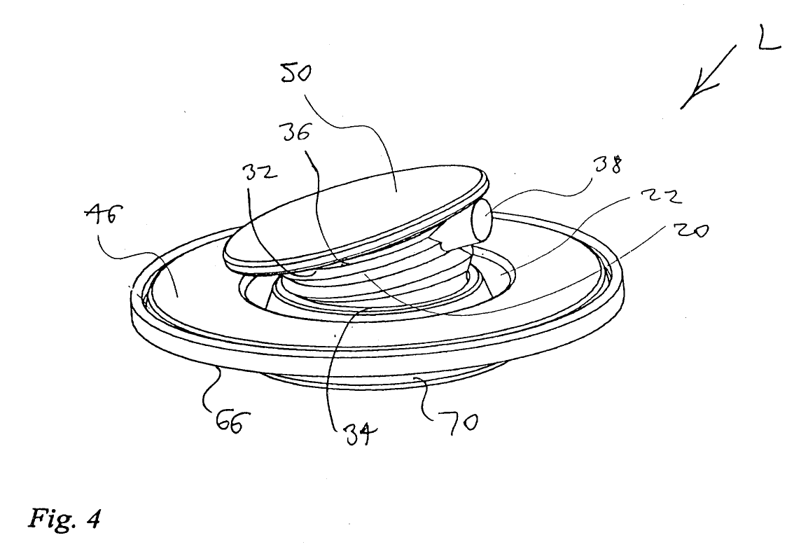

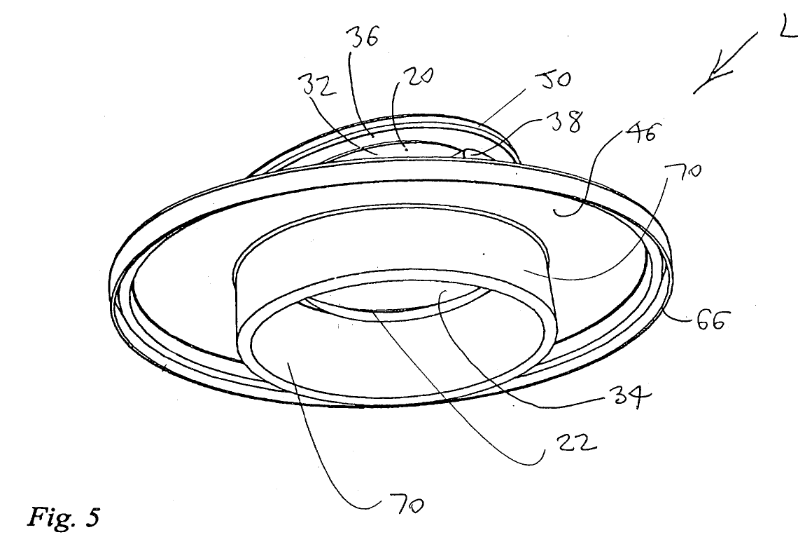

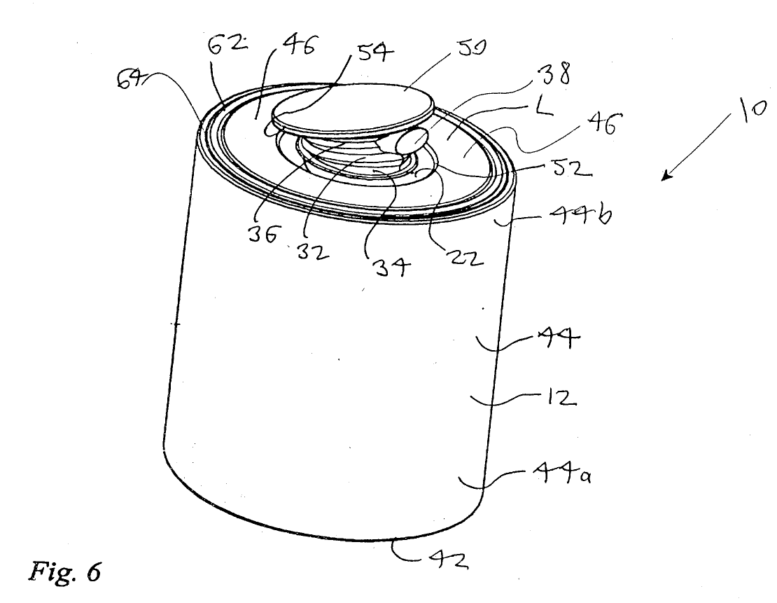

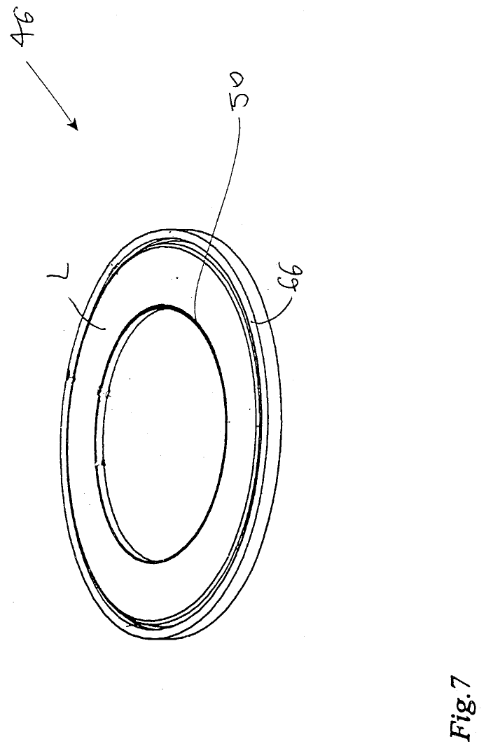

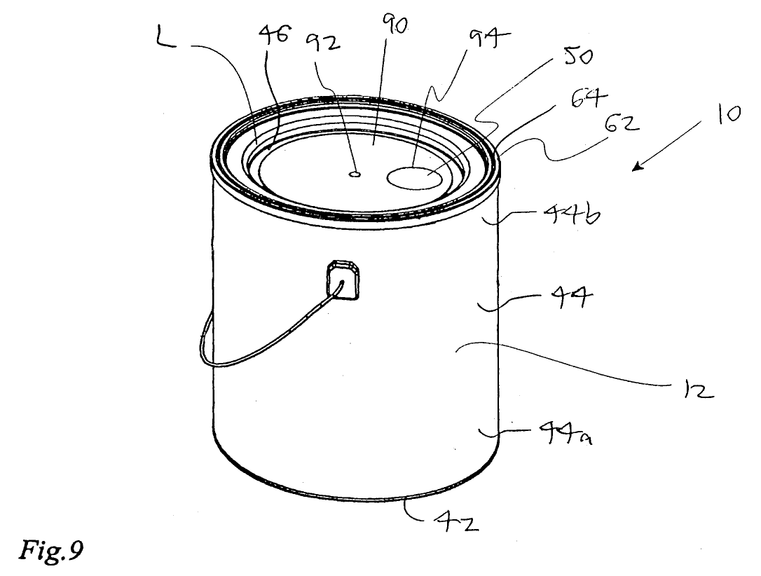

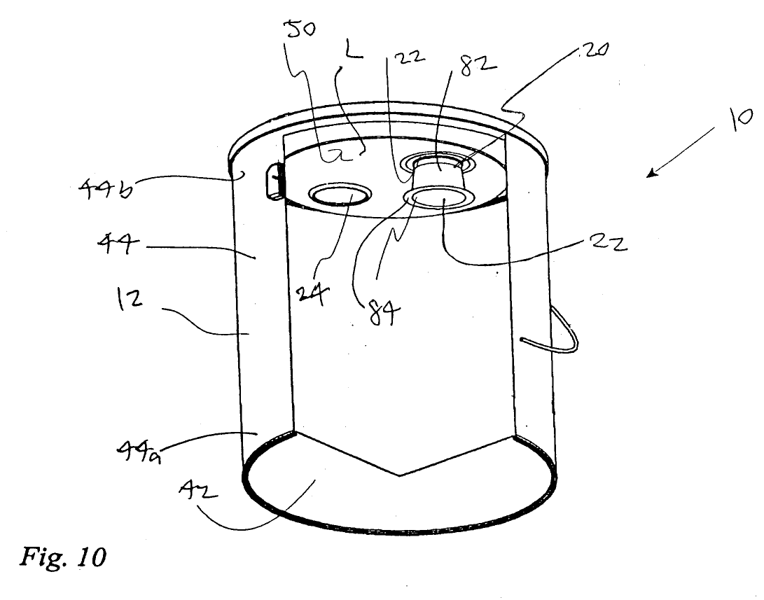

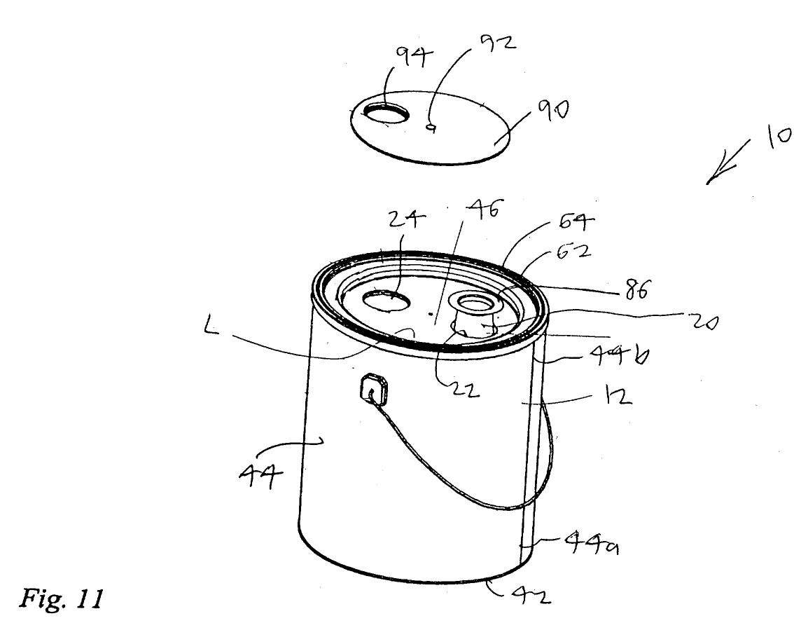

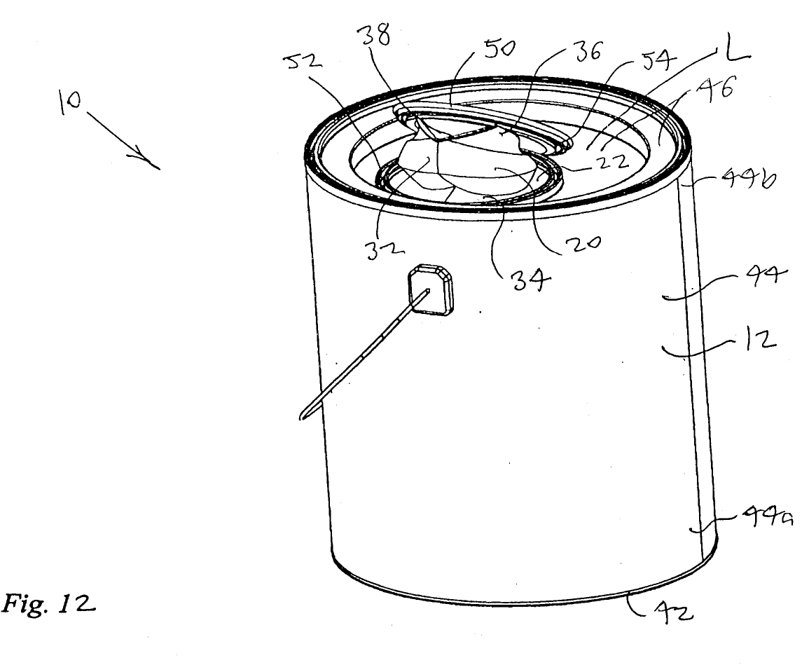

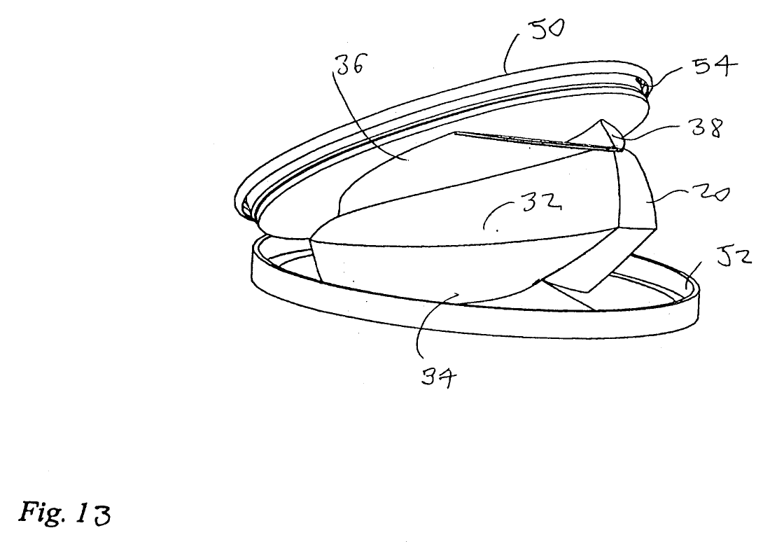

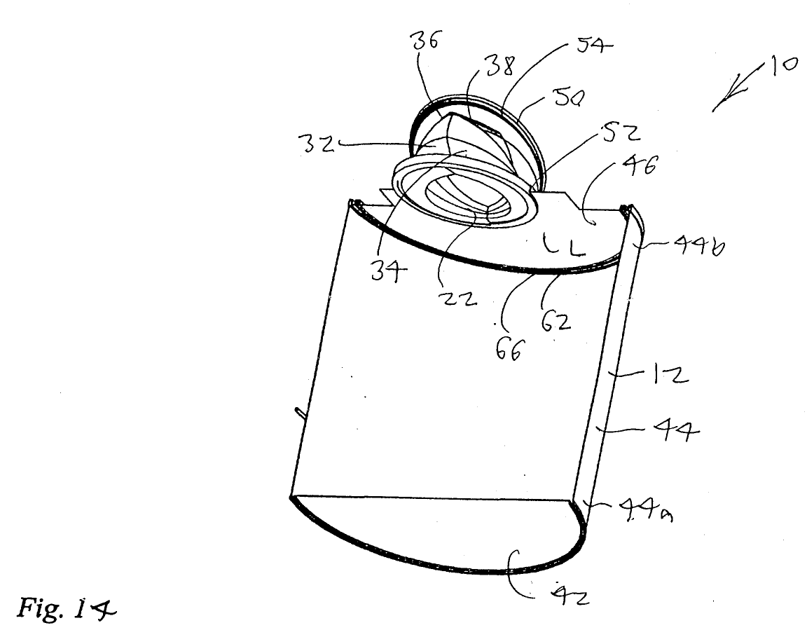

Referring to FIGS. 1-14, a product vessel 10 is disclosed having a vessel wall 12 with a spout port 22 sealingly fitted with a retractable spout 20 for retaining and pouring paint or other flowable material. One preferred embodiment of retractable spout 20 is a bellows retractable spout which folds toward and preferably into vessel 10 when retracted for vessel 10 closure and storage, and which unfolds outwardly from vessel 10 when extended for use. Another preferred embodiment of retractable spout 20 is a sliding retractable spout, the greater portion of which slides sealingly within the spout port 22 into vessel 10 when retracted and sealingly out of vessel 10 when extended.

For both preferred embodiments, vessel 10 preferably is a metal or plastic can including a can bottom wall 42, a cylindrical can side wall 44 having a can side wall lower end 44a sealingly connected to can bottom wall 42 and extending upwardly from can bottom wall 42 to a can side wall upper end 44b and having a can top wall 46 extending sealingly across the can side wall upper end 44b. The spout port 22 preferably is provided in the can top wall 46, as illustrated, but also may be in any other can wall.

### FIRST PREFERRED EMBODIMENT

For the bellows retractable spout 20 embodiment the spout 20 includes a bellows spout tube 32 having a spout connected end 34 sealingly connected around the spout port 22. The spout tube 32 has a spout protruding end 36 extendable from the spout port 22 by axially unfolding bellows spout tube 32, as indicated above, and retractable toward and preferably into the spout port 22 by folding bellows spout tube 32. See FIGS. 1-7 and 12-14.

The spout tube 32 preferably has a lateral spout opening 38 adjacent to spout protruding end 36 for discharging flowable material from inside the vessel 10. Lateral spout opening 38 collapses and thereby closes when spout 20 is retracted and opens when spout 20 is extended. More specifically, the spout opening 38 preferably is located at the side of the spout protruding end 36, the spout tube 32 having a skewed bellows configuration in which the pitch of the bellows on the spout tube 32 side having the spout opening 38 is larger than the pitch of the bellows on the spout tube 32 side opposite the spout opening 38, so that the spout opening 38 automatically closes when the bellows spout 20 is compressed for retraction and automatically opens when the bellows spout 20 is elongated for extension. To this end, the spout tube 32 side having the spout opening 38 preferably has larger bellows undulations and the spout tube 32 side opposite the spout opening 38 has smaller bellows undulations. Spout tube 32 extension and automatic opening of the spout opening 38 may result solely from manual pulling of the spout tube 32 away from spout port 22 or from resilience of spout tube 32 material.

The spout protruding end 36 itself preferably is covered by a spout port lid 50 secured to spout protruding end 36 with a suitable adhesive and extending laterally beyond spout 20. Spout protruding end 36 may include an integral spout end wall (not shown) or spout protruding end 36 may be closed by spout port lid 50. An outwardly opening spout port groove 52 preferably encircles the spout port 22 and a circumferential port lid flange 54 preferably extends from spout port lid 50 toward spout port 22 and is sealingly fittable into spout port groove 52 upon full retraction of the spout tube 32, in the manner of a conventional paint can lid. This flange and groove or tongue and groove configuration for sealingly mounting the spout port lid 50 is of the very same trusted sealing structure used to sealingly mount paint can lids onto paint cans, and is known in the industry as a double friction seal, and the term double friction seal structure will be understood to have this meaning in the appended claims.

Can top wall 46 preferably is a can lid L which is separable from can side wall 44, which preferably has a conventional and standard double friction seal, so that the can lid L including the retractable spout 20, spout port 22 and spout port lid 50 itself constitutes an embodiment of the present invention which is suitable for mounting onto vessels of existing design and size such as paint cans. Can lid L includes a can lid rim 62 extending radially inward from can side wall upper end 44b with an outwardly opening can circumferential groove 64, and the can top wall 46 has a corresponding circumferential can lid flange 66 sealingly fittable to the can circumferential groove 64 in the manner of a conventional paint can lid.

A spout sleeve 70 preferably is provided in the form of an annular spout retaining wall secured to the inward face of can top wall 46, encircling the spout port 22 and extending downwardly into the can 10 interior. As spout 20 retracts, its folded body enters and is retained within spout sleeve 70, which shields spout 20 against the impact of heavy, viscous paint or other flowable material in the can, such as during can 10 shaking during mixing.

### SECOND PREFERRED EMBODIMENT

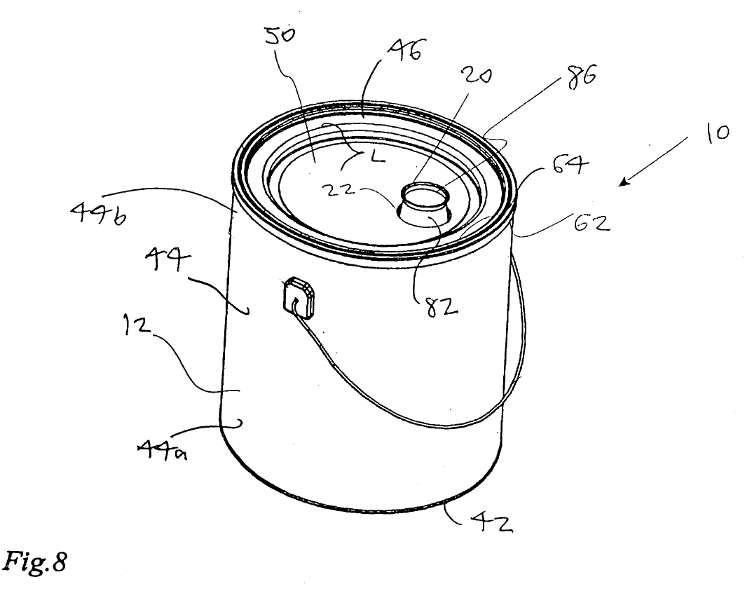

For the tubular retractable spout 20 embodiment, the spout 20 includes a smooth, regular spout tube 82 sealingly and slidably mounted within spout port 22. See FIGS. 8-11. Tubular retractable spout 20 has an inward spout abutment rim 84 protruding radially outwardly from the spout 20 inward end for sealingly abutting the inward face of can top wall 46 surrounding spout port 22 during full spout 20 extension and has an outward spout abutment rim 86 protruding radially outwardly from the spout 20 outward end for sealingly abutting the outward face of the can top wall 46 surrounding spout port 22 during full spout 20 retraction. Once again, the spout protruding end 36 may include a spout port lid 50 secured to spout protruding end 36 with a suitable adhesive and extending radially beyond the spout 20, and a spout sleeve 70 is optionally provided.

A rotatable closure plate 90 preferably is rotatably mounted on a plate rivet or plate pin 92 or other equivalent structure extending through closure plate 90 into the can top wall 46. The closure plate 90 has a spout plate port 94 which rotates with the plate 90 until it registers with the spout port 22 to permit spout 20 extension and rotates out of registration with the spout port 22 and so that plate 90 covers the retracted spout to sealingly close spout port 22. An air entry port 24 is optionally provided in can top wall 46 and is diametrically offset from spout port 22. In this instance, an air plate port 96 is provided in closure plate 90 which registers with and thereby opens air entry port 24 simultaneously with spout plate port 94 registration with spout port 22 to equalize pressure inside the can 10 and thus to permit the smooth flow of flowable material out of can 10 through spout 20.

To use the can 10, closure plate 90 is rotated until the spout plate port 94 registers with spout port 22, and then the spout 20 is slid outwardly against light friction resistance between the spout 20 and spout port 22 until inward spout abutment rim 84 makes sealingly contact with the can top wall 46 inward face for pouring of flowable material out of can 10. Then spout 20 is slid inwardly until the outward spout abutment rim 86 makes sealing contact with the can top wall 46 outward face, and then closure plate 90 is rotated so that the spout plate port 94 no longer registers with the spout port 22 and spout port 22 is thereby covered and sealed by closure plate 90.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A vessel for containing a flowable material, comprising:
a retractable and extendable spout for pouring flowable material;
and a vessel wall with a spout port into which said spout is sealingly fitted.

2. The vessel of claim 1, wherein said vessel is a can comprising:
a can bottom wall;
a cylindrical can side wall having a can side wall lower end sealingly connected to said can bottom wall and extending upwardly from said can bottom wall to a can side wall upper end;
and a can top wall extending sealingly across said can side wall upper end;
wherein said spout port opens through said can top wall.

3. The vessel of claim 2, wherein said spout comprises an bellows spout tube having a spout connected end sealingly connected around said spout port and having a spout protruding end extendable from said spout port by axially unfolding said bellows spout tube and retractable toward said spout port by axially folding said bellows spout tube, said spout protruding end comprising a spout opening.

4. The vessel of claim 3, wherein said spout opening is lateral and adjacent to said spout protruding end, such that said spout opening collapses and closes when said spout is retracted and opens when said spout is extended.

5. The vessel of claim 3, wherein said spout protruding end comprises a spout port lid extending radially beyond said spout protruding end.

6. The vessel of claim 5, wherein said can top wall comprises an upwardly opening spout port groove encircling said spout port and wherein said spout port lid comprises a port lid flange extending from said spout port lid toward said spout port and sealingly fittable into said spout port groove upon full retraction of said spout tube.

7. The vessel of claim 2, wherein said can top wall is separable from the can side wall, and said can side wall upper end comprises a can lid rim extending radially inward with an upwardly opening can circumferential groove and said can top wall has a circumferential can lid flange sealingly fittable to said can circumferential groove.

8. The vessel of claim 2, wherein said can top wall comprises a top wall inward face and a top wall outward face, said vessel additionally comprising an annular and tubular spout sleeve secured to said top wall inward face, encircling said spout port and extending into said can;
such that, as said spout is folded and thereby retracted, at least a portion of said spout passes through said spout port and enters and is retained within said spout sleeve.

9. The vessel of claim 2, wherein said can top wall comprises a top wall inward face and a top wall outward face, and wherein said spout comprises a tubular spout sealingly and slidably mounted within said spout port, said spout comprising a spout inward end and a spout outward end and comprising an inward spout abutment rim protruding radially outward from said spout inward end for sealingly abutting said top wall inward face surrounding said spout port during full extension of said spout and has an outward spout abutment rim protruding radially outwardly from said spout outward end for sealingly abutting said top wall outward face surrounding said spout port during full retraction of said spout.

10. The vessel of claim 9, wherein said spout opening is lateral and adjacent to said spout protruding end, such that said spout opening collapses and closes when said spout is retracted and opens when said spout is extended.

11. The vessel of claim 9, additionally comprising:
a plate pin;
and a rotatable closure plate having a spout plate port and being rotatably mounted on said plate pin, said plate pin extending outwardly from can top wall;
wherein said spout plate port rotates with said closure plate until said spout plate port registers with said spout port thereby permitting extension of said spout through said spout plate port, and rotates out of registration with said spout port such that said closure plate covers said spout port and said spout when said spout is retracted into said can, thereby sealingly closing said spout port.

12. The vessel of claim 11, additionally comprising:
an air entry port in said can top wall;
wherein said closure plate additionally comprises an air plate port radially offset from said plate pin which registers with and thereby opens said air entry port simultaneously with spout plate port registration with said spout port, to equalize pressure inside said can and thereby to permit smooth flow of flowable material out of said can through said spout.

13. The vessel of claim 7, additionally comprising a can lid comprising said can top wall, said spout and said spout port lid.

14. A can lid for mounting onto a can for containing a flowable material, the can comprising a can bottom wall and a cylindrical can side wall having a can side wall upper end and having a can side wall lower end sealingly connected to the can bottom wall and extending upwardly from the can bottom wall to the can side wall upper end, and a can lid rim extending radially inward with an upwardly opening can circumferential groove, the can lid comprising:
a can top wall separable from the can side wall and having a circumferential can lid flange sealingly fittable to the can circumferential groove and having a spout port and an upwardly opening spout port groove encircling said spout port;
a retractable and extendable spout for pouring flowable material out of the can, said spout being sealingly fitted into said spout port and having a spout protruding end;
and a spout port lid sized to cover and extend radially beyond said spout protruding end, and secured to said spout protruding end and including a port lid flange extending from said spout port lid toward said spout port and sealingly fittable into said spout port groove upon full retraction of said spout.

15. A can lid for mounting onto a can for containing a flowable material, the can comprising a can bottom wall and a cylindrical can side wall having a can side wall upper end and having a can side wall lower end sealingly connected to the can bottom wall and extending upwardly from the can bottom wall to the can side wall upper end, the can lid comprising:
a can top wall separable from the can side wall and having a spout port;
a can lid double friction seal structure for sealingly securing said can lid to said can side wall upper end;
a retractable and extendable spout for pouring flowable material out of the can, said spout being sealingly fitted into said spout port and having a spout protruding end;
a spout port lid sized to cover and extend radially beyond said spout protruding end and sized to fit to said spout port;
and a spout port lid double friction seal structure for sealingly securing said spout port lid to said spout port upon full retraction of said spout.
